(19) United States
(12) Patent Application Publication
(10) Pub. No.: US 2019/0255828 A1
(43) Pub. Date: Aug. 22, 2019

(54) SHEET-LIKE COMPOSITE FOR PRODUCING DIMENSIONALLY STABLE FOOD-PRODUCT CONTAINERS HAVING A BIOBASED BARRIER LAYER

(71) Applicant: SIG TECHNOLOGY AG, Neuhausen am Rheinfall (CH)

(72) Inventors: Jannis OCHSMANN, Frechen (DE); Alexander PAULING, Juchen (DE); Daniel HEINZE, Linnich (DE)

(21) Appl. No.: 16/315,913

(22) PCT Filed: Jul. 25, 2017
(86) PCT No.: PCT/EP2017/068766

§ 371 Date: Jan. 7, 2019

(30) Foreign Application Priority Data
Jul. 27, 2016 (DE) 102016213838.3

(51) Int. Cl. B32B 27/34; B32B 3/26; B32B 27/10; B32B 37/18; B65B 3/02; B65B 3/04; B65D 65/40; B65D 75/26

(52) U.S. Cl. CPC B32B 27/34; B32B 3/266; B32B 27/10; B32B 37/182; B65B 3/02; B32B 2439/70; B65D 65/40; B65D 75/26; B32B 2307/7244; B32B 2439/62; B65B 3/04

(57) ABSTRACT

The invention relates to a sheet-like composite comprising as layers of a layer sequence from an outer side of the sheet-like composite to an inner side of the sheet-like composite a) a carrier layer, and b) a barrier layer; said barrier layer a. comprising a polyamide, and b. being characterized by a methylene/amide coefficient, as determined in accordance with the method described herein, in a range from 0.3 to 0.7. Furthermore, the invention relates to a container precursor, to a closed container, to production methods for the aforementioned and to a use of a polyamide in a barrier layer of a sheet-like composite having a carrier layer for producing a food-product container.

The present invention relates to a sheet-like composite comprising as layers of a layer sequence from an outer side of the sheet-like composite to an inner side of the sheet-like composite
a) a carrier layer, and
b) a barrier layer;
   said barrier layer
a. comprising a polyamide, and
b. being characterized by a methylene/amide coefficient, as determined in accordance with the method described herein, in a range from 0.3 to 0.7.

Furthermore, the invention relates to a container precursor, to a closed container, to production methods for the aforementioned and to a use of a polyamide in a barrier layer of a sheet-like composite having a carrier layer for producing a food-product container.

For a long time, food products, be it food products for human consumption or else animal food products, have been preserved by storing them either in a can or in an item of glassware closed with a lid. Here, shelf life can firstly be increased by separately sterilizing the food product and the container, in this case an item of glassware or a can, to the maximum possible extent and then filling the food product into the container and closing said container. However, these tried and tested measures for increasing the shelf life of food products have a range of disadvantages, for example an again necessary downstream sterilization. Owing to their essentially cylindrical shape, cans and glassware have the disadvantage that a highly dense and space-saving storage is not possible. Moreover, cans and glassware have a considerable inherent weight, which leads to an increased energy expenditure during transport. In addition, a rather high energy expenditure is required for the production of glass, tinplate or aluminium, even if the raw materials used for this purpose come from recycling. In the case of glassware, an increased transport expenditure is an additional complicating factor. The glassware are usually pre-manufactured in a glass factory and must then be transported with utilization of considerable transport volumes to the food-product-filling plant. Furthermore, glassware and cans can only be opened with a considerable expenditure of force or with the aid of tools and thus rather inconveniently. In the case of cans, an additional factor is a high risk of injury due to sharp edges arising during opening. In the case of glassware, a common occurrence is that glass splinters get into the food product during filling or opening of the filled glassware, which glass splinters can lead in the worst case to internal injuries during consumption of the food product. Moreover, both cans and glassware must be fixed with labels in order to label and advertise the food-product contents. The glassware and cans cannot be readily directly printed with information and advertisements. Thus, in addition to the actual print, a substrate for this purpose, a piece of paper or a suitable film, and also a fastener, an adhesive or a seal are required.

Other packaging systems are known from the prior art for storing food products over a long period with minimum impairments. These are containers produced from sheet-like composites—frequently also referred to as laminates. Such sheet-like composites are frequently constructed from a thermoplastics layer, a carrier layer which usually consists of cardboard or paper and which gives the container a dimensional stability, an adhesion-promoter layer, a barrier layer and a further plastics layer, as disclosed in, inter alia, WO 90/09926 A2. Since the carrier layer gives dimensional stability to the container made from the laminate, these containers, in contrast to film bags, are to be considered as a further development of the aforementioned glassware and cans.

Here, these laminate containers already have many advantages over the conventional glassware and cans. Nevertheless, there are also possibilities of improvement for these packaging systems. For example, there are demands for a longest possible shelf life of food products in the laminate containers, for more environmentally friendly laminate containers and for laminate containers having an improved opening behaviour.

In general, it is an object of the present invention to at least partly overcome a disadvantage arising from the prior art. It is a further object of the invention to provide a dimensionally stable laminate food-product container allowing a longer shelf life of the food product. Here, the shelf life preferably concerns the quality of the food product, more particularly the preservation of a composition of the food product. Furthermore, it is an object of the invention to provide a dimensionally stable laminate food-product container having an improved oxygen barrier or light barrier or having both. It is a further object of the invention to provide a laminate for a dimensionally stable laminate food-product container, wherein the adhesive strength of the barrier layer to the carrier layer, especially a cardboard carrier layer, is improved. Here, preference is given to using minimal adhesion promoter. Furthermore, it is an object of the invention to provide a dimensionally stable laminate food-product container having improved dimensional stability. It is a further object of the invention to reduce a taste-related impairment of a food product, especially in the case of long-life milk and beer, in a dimensionally stable laminate food-product container.

Particularly preferably, the aforementioned objects are achieved by a dimensionally stable laminate food-product container having no metal layer.

Moreover, it is an object of the invention to provide a dimensionally stable laminate food-product container having a less light-permeable oxygen barrier. Furthermore, it is an object of the invention to provide a more environmentally friendly dimensionally stable laminate food-product container. Here, the container preferably has a barrier composed of a largest possible fraction of renewable raw materials. Furthermore, the raw materials of the barrier preferably have an improved greenhouse gas balance, especially for CO₂.

Moreover, it is an object of the invention to provide, in a dimensionally stable food-product container, a region which can be opened without an excessively large expenditure of force or effort to form a clean hole and has, at the same time, a high tightness, especially gas-tightness and liquid-tightness, in the unopened state, meaning that food products can be stored in a fresh state in said container for as long as possible; even with mechanical stress such as pressure on the container. During hole formation, for example by means of an openable closure via pushing-in, cutting or pulling-out, what is particularly undesired is the formation of threads and tongues, which have an adverse effect on the opening, emptying or aeration behaviour of the container contents. If the hole is formed by penetration by means of a drinking straw, it is further preferred that the drinking straw be enclosed as tightly as possible by the edges of the hole so that, in the case of full liquid containers, escape of liquid is kept to a minimum. Here, it is further preferred to have to use minimal adhesion promoter, if any.

A contribution to at least partly satisfying at least one of the above objects is made by the independent claims. The dependent claims provide preferred embodiments which contribute to at least partly satisfying at least one of the objects.

A contribution to satisfying at least one of the objects of the invention is made by an embodiment 1 of a sheet-like composite 1 comprising as layers of a layer sequence from an outer side of the sheet-like composite to an inner side of the sheet-like composite
a) a carrier layer, and
b) a barrier layer;
said barrier layer
a. comprising a polyamide, and
b. being characterized by a methylene/amide coefficient, as determined in accordance with the method described herein, in a range from 0.3 to 0.7, preferably from 0.31 to 0.68, more preferably from 0.32 to 0.67, most preferably from 0.32 to 0.65. Preferably, the barrier layer comprises the polyamide to an extent of at least 50% by weight, more preferably of at least 60% by weight, more preferably of at least 70% by weight, more preferably of at least 80% by weight, more preferably of at least 90% by weight, most preferably of at least 95% by weight, based in each case on the weight of the barrier layer.

In an inventive embodiment 2, the sheet-like composite 1 is designed according to embodiment 1, wherein the barrier layer consists of the polyamide, said polyamide being characterized by a methylene/amide coefficient, as determined in accordance with the method described herein, in a range from 0.3 to 0.7, preferably from 0.31 to 0.68, more preferably from 0.32 to 0.67, most preferably from 0.32 to 0.65.

In an inventive embodiment 3, the sheet-like composite 1 is designed according to embodiment 1 or 2, wherein a carbon fraction of the polyamide is biobased to an extent of at least 40%, preferably to an extent of at least 50%, more preferably to an extent of at least 60%, more preferably to an extent of at least 70%, more preferably to an extent of at least 80%, even more preferably to an extent of at least 90%, even more preferably to an extent of at least 95%, most preferably to an extent of 100%, in accordance with the measurement method described herein.

In an inventive embodiment 4, the sheet-like composite 1 is designed according to any of the preceding embodiments, wherein the polyamide is obtainable by polycondensation from a diacid and a diamine. A preferred diacid is one selected from the group consisting of a butanedioic acid, a hexanedioic acid, an octanedioic acid, a decanedioic acid and a dodecanedioic acid or a combination of at least two of the aforementioned. Here, a butanedioic acid is also referred to as succinic acid. Furthermore, a hexanedioic acid is also referred to as adipic acid. An octanedioic acid is also called suberic acid. Furthermore, a decanedioic acid is also called sebacic acid. A preferred decanedioic acid is a 1,10-decanedioic acid. A preferred dodecanedioic acid is a 1,12-dodecanedioic acid. A preferred diamine is a hexamethylenediamine or a decamethylenediamine or both. A preferred hexamethylenediamine is a 1,6-hexamethylenediamine. A preferred decamethylenediamine is a 1,10-decamethylenediamine.

In an inventive embodiment 5, the sheet-like composite 1 is designed according to any of the preceding embodiments, wherein the polyamide is one selected from the group consisting of a PA410, PA610, PA1010, PA1012, PA612, PA69 and a PA11 or a combination of at least two thereof.

In an inventive embodiment 6, the sheet-like composite 1 is designed according to any of the preceding embodiments, wherein the sheet-like composite comprises no metal to an extent of more than 10% by weight, preferably to an extent of more than 5% by weight, more preferably to an extent of more than 3% by weight, most preferably to an extent of more than 1% by weight, based in each case on the weight of the sheet-like composite. Preferably, the barrier layer, preferably the sheet-like composite, comprises no metal.

In an inventive embodiment 7, the sheet-like composite 1 is designed according to any of the preceding embodiments, wherein the sheet-like composite comprises no further layer between the barrier layer and the carrier layer. More particularly, the sheet-like composite preferably comprises no polymer layer between the barrier layer and the carrier layer, especially preferably no adhesion-promoter layer.

In an inventive embodiment 8, the sheet-like composite 1 is designed according to any of the preceding embodiments, wherein the sheet-like composite is characterized by an adhesive strength between the carrier layer and the barrier layer of at least 0.3 N/15 mm, preferably of at least 0.5 N/15 mm, more preferably of at least 0.7 N/15 mm.

In an inventive embodiment 9, the sheet-like composite 1 is designed according to any of the preceding embodiments, wherein the sheet-like composite further comprises an outer polymer layer, said outer polymer layer superimposing the carrier layer on a side of the carrier layer that is facing away from the barrier layer. A preferred outer polymer layer comprises an LDPE to an extent of at least 50% by weight, preferably to an extent of at least 60% by weight, more preferably to an extent of at least 70% by weight, even more preferably to an extent of at least 80% by weight, most preferably to an extent of at least 90% by weight, based in each case on the weight of the outer polymer layer.

In an inventive embodiment 10, the sheet-like composite 1 is designed according to any of the preceding embodiments, wherein the sheet-like composite further comprises an inner polymer layer, said inner polymer layer superimposing the barrier layer on a side of the barrier layer that is facing away from the carrier layer. Preferably, the inner polymer layer comprises a polymer produced by means of a metallocene catalyst to an extent of from 10 to 90% by weight, preferably to an extent of from 25 to 90% by weight, more preferably to an extent of from 30 to 80% by weight, based in each case on the total weight of the inner polymer layer. In a further preferred embodiment, the inner polymer layer comprises a polymer blend, said polymer blend comprising an mPE to an extent of from 10 to 90% by weight, preferably to an extent of from 25 to 90% by weight, more preferably to an extent of from 30 to 80% by weight, and a further polymer to an extent of at least 10% by weight, preferably to an extent of at least 15% by weight, more preferably to an extent of at least 20% by weight, based in each case on the total weight of the polymer blend.

In an inventive embodiment 11, the sheet-like composite 1 is designed according to any of the preceding embodiments, wherein the carrier layer has at least one hole, said hole being covered at least by the barrier layer. Preferably, the hole is further covered by the inner polymer layer or the outer polymer layer or both. Layers covering the hole are referred to herein as hole-covering layers. If at least 2 hole-covering layers are present, the hole-covering layers in the hole preferably form a layer sequence of layers joined to one another in the hole.

In an inventive embodiment 12, the sheet-like composite 1 is designed according to any of the preceding embodiments, wherein the sheet-like composite is designed to produce a closed container; wherein the closed container has an edge, preferably 2, more preferably 3, more preferably 4, most preferably 12 edges; wherein the closed container
a. can be opened with application of an average opening work in a range from 300 to 500 mJ, preferably from 350 to 490 mJ, more preferably from 380 to 480 mJ, most preferably from 400 to 470 mJ, in each case in accordance with the opening test described herein; or
b. can be opened with application of an average maximum torque in a range from 0.3 to 0.47 Nm, preferably from 0.35 to 0.46 Nm, more preferably from 0.37 to 0.45 Nm, most preferably from 0.38 to 0.44 Nm, in each case in accordance with the opening test described herein for opening from a rotation angle of 40°;
c. or both.

In an inventive embodiment 13, the sheet-like composite 1 is designed according to any of embodiments 9 to 12, wherein the outer polymer layer on a side of the outer polymer layer that is facing away from the carrier layer is superimposed with a colour layer, preferably a decoration. Preferably, the colour layer comprises at least one colourant.

In an inventive embodiment 14, the sheet-like composite 1 is designed according to any of the preceding embodiments, wherein the carrier layer comprises one selected from the group consisting of cardboard, paperboard, and paper, or a combination of at least two thereof.

A contribution to satisfying at least one of the objects of the invention is made by an embodiment 1 of a method 1 comprising as method steps
a) providing a sheet-like composite precursor comprising a carrier layer;
b) providing a composition comprising a polyamide; and
c) superimposing a first side of the carrier layer with the composition thereby obtaining a barrier layer superimposing the carrier layer on the first side;
   said composition being characterized by a methylene/amide coefficient, as determined in accordance with the method described herein, in a range from 0.3 to 0.7, preferably from 0.31 to 0.68, more preferably from 0.32 to 0.67, most preferably from 0.32 to 0.65. Preferably, the composition comprises the polyamide to an extent of at least 50% by weight, more preferably of at least 60% by weight, more preferably of at least 70% by weight, more preferably of at least 80% by weight, more preferably of at least 90% by weight, most preferably of at least 95% by weight, based in each case on the weight of the composition.

In an inventive embodiment 2, the method 1 is designed according to embodiment 1, wherein the composition consists of the polyamide, said polyamide being characterized by a methylene/amide coefficient, as determined in accordance with the method described herein, in a range from 0.3 to 0.7, preferably from 0.31 to 0.68, more preferably from 0.32 to 0.67, most preferably from 0.32 to 0.65.

In an inventive embodiment 3, the method 1 is designed according to embodiment 1 or 2, wherein the polyamide is obtained before method step b) by polycondensation from a diacid and a diamine. Preferred diacids and diamines are specified herein in connection with the sheet-like composite.

In an inventive embodiment 4, the method 1 is designed according to any of embodiments 1 to 3, wherein, in method step c), the composition is directly applied to the carrier layer.

In an inventive embodiment 5, the method 1 is designed according to any of embodiments 1 to 4, wherein a carbon fraction of the polyamide is biobased to an extent of at least 40%, preferably to an extent of at least 50%, more preferably to an extent of at least 60%, more preferably to an extent of at least 70%, more preferably to an extent of at least 80%, even more preferably to an extent of at least 90%, even more preferably to an extent of at least 95%, most preferably to an extent of 100%, in each case in accordance with the measurement method described herein.

In an inventive embodiment 6, the method 1 is designed according to any of embodiments 1 to 5, wherein the polyamide is one selected from the group consisting of a PA410, PA610, PA1010, PA1012, PA612, PA69 and a PA11 or a combination of at least two thereof.

In an inventive embodiment 7, the method 1 is designed according to any of embodiments 1 to 6, wherein the barrier layer comprises no metal to an extent of more than 10% by weight, preferably to an extent of more than 5% by weight, more preferably to an extent of more than 3% by weight, most preferably to an extent of more than 1% by weight, based in each case on the weight of the barrier layer. Preferably, the barrier layer, preferably the sheet-like composite, comprises no metal.

In an inventive embodiment 8, the method 1 is designed according to any of embodiments 1 to 7, wherein the carrier layer comprises one selected from the group consisting of cardboard, paperboard, and paper, or a combination of at least two thereof.

In an inventive embodiment 9, the method 1 is designed according to any of embodiments 1 to 8, wherein the carrier layer has at least one hole, the composition being applied in method step c) such that the barrier layer covers the hole on the first side of the carrier layer. In a further preferred embodiment, in method step c) or in a further method step before or after method step c), the carrier layer having the hole is superimposed with an outer polymer composition on a further side opposite to the first side thereby obtaining an outer polymer layer superimposing the carrier layer on the further side. Here, the outer polymer composition is preferably applied such that the outer polymer layer covers the hole on the further side of the carrier layer. In a further preferred embodiment, in method step c) or in a further method step after method step c), the barrier layer is superimposed with an inner polymer composition on a side facing away from the carrier layer thereby obtaining an inner polymer layer superimposing the barrier layer on a side facing away from the carrier layer. Here, the inner polymer composition is preferably applied such that the inner polymer layer covers the hole in the carrier layer. Preferably, the barrier layer and the outer polymer layer or the inner polymer layer or both form hole-covering layers, hence a layer sequence of layers joined to one another at least in part in the hole. A preferred outer polymer composition comprises an LDPE to an extent of at least 50% by weight, preferably to an extent of at least 60% by weight, more preferably to an extent of at least 70% by weight, even more preferably to an extent of at least 80% by weight, most preferably to an extent of at least 90% by weight, based in each case on the weight of the outer polymer composition. Preferably, the inner polymer composition comprises a polymer produced by means of a metallocene catalyst to an extent of from 10 to 90% by weight, preferably to an extent of from 25 to 90% by weight, more preferably to an extent of from 30 to 80% by weight, based in each case on the total weight of the inner polymer composition. In a further preferred embodiment, the inner polymer composition comprises a polymer blend, said polymer blend comprising an mPE to an extent of from 10 to 90% by weight, preferably to an extent of from 25 to 90% by weight, more preferably to an extent of from 30 to 80% by weight, and a further polymer to an extent of at least 10% by weight, preferably to an extent of at least 15% by weight, more preferably to an extent of at least 20% by weight, based in each case on the total weight of the polymer blend.

A contribution to satisfying at least one of the objects of the invention is made by an embodiment 1 of a sheet-like composite 2 obtainable by the method 1 according to any of its embodiments 1 to 9.

A contribution to satisfying at least one of the objects of the invention is made by an embodiment 1 of a container precursor 1 comprising the sheet-like composite 1 or 2 according in each case to any of its above embodiments.

In an inventive embodiment 2, the container precursor 1 is designed according to embodiment 1, wherein the sheet-like composite has at least 3, preferably at least 4, more preferably at least 6, folds.

In an inventive embodiment 3, the container precursor 1 is designed according to embodiment 1 or 2, wherein the sheet-like composite comprises a first longitudinal edge and a further longitudinal edge, the first longitudinal edge being joined to the further longitudinal edge thereby forming a longitudinal seam of the container precursor.

In an inventive embodiment 4, the container precursor 1 is designed according to any of its embodiments 1 to 3, wherein the sheet-like composite is a blank for producing an individual container.

A contribution to satisfying at least one of the objects of the invention is made by an embodiment 1 of a closed container 1 comprising the sheet-like composite 1 or 2 according in each case to any of its above embodiments.

In an inventive embodiment 2, the closed container 1 is designed according to embodiment 1, wherein the sheet-like composite comprises a first longitudinal edge and a further longitudinal edge, the first longitudinal edge being joined to the further longitudinal edge thereby forming a longitudinal seam of the closed container.

In an inventive embodiment 3, the closed container 1 is designed according to embodiment 1 or 2, wherein the closed container comprises a food product.

A contribution to satisfying at least one of the objects of the invention is made by an embodiment 1 of a method 2 comprising as method steps
A. providing the sheet-like composite 1 or 2 according in each case to any of its above embodiments, comprising a first longitudinal edge and a further longitudinal edge;
B. folding the sheet-like composite; and
C. contacting the first longitudinal edge with the further longitudinal edge and joining the first longitudinal edge to the further longitudinal edge thereby obtaining a longitudinal seam.

A contribution to satisfying at least one of the objects of the invention is made by an embodiment 1 of a container precursor 2 obtainable by the method 2 according to its embodiment 1.

A contribution to satisfying at least one of the objects of the invention is made by an embodiment 1 of a method 3 comprising as method steps
a. providing the container precursor 1 or 2 according in each case to any of its above embodiments;
b. forming a base region of the container precursor by folding the sheet-like composite;
c. closing the base region;
d. filling the container precursor with a food product, and
e. closing the container precursor in a head region thereby obtaining a closed container.

In an inventive embodiment 2, the method 3 is designed according to embodiment 1, wherein the method further comprises a method step f. joining the closed container to an opening aid.

A contribution to satisfying at least one of the objects of the invention is made by an embodiment 1 of a closed container 2 obtainable by the method 3 according to its embodiment 1 or 2.

In an inventive embodiment 2, the closed container 2 is designed according to embodiment 1, wherein the closed container
i) can be opened with the opening aid with application of an average opening work in a range from 300 to 500 mJ, preferably from 350 to 490 mJ, more preferably from 380 to 480 mJ, most preferably from 400 to 470 mJ, in each case in accordance with the opening test described herein; or
ii) can be opened by a rotation of the opening aid with application of an average maximum torque in a range from 0.3 to 0.47 Nm, preferably from 0.35 to 0.46 Nm, more preferably from 0.37 to 0.45 Nm, most preferably from 0.38 to 0.44 Nm, in each case from a rotation angle of 40° in accordance with the opening test described herein;
iii) or both.

A contribution to satisfying at least one of the objects of the invention is made by an embodiment 1 of a closed container 3 comprising a sheet-like composite, said sheet-like composite comprising as layers of a layer sequence from an outer side of the sheet-like composite to an inner side of the sheet-like composite
a) a carrier layer and
b) a barrier layer,
   said barrier layer comprising a polyamide, preferably consisting of a polyamide, said carrier layer having at least one hole, said hole being covered at least by the barrier layer, said closed container being joined to an opening aid, said opening aid being arranged and designed for an opening of the closed container in the hole.

In an inventive embodiment 2, the closed container 3 is designed according to embodiment 1, wherein the closed container
i) can be opened with the opening aid with application of an average opening work in a range from 300 to 500 mJ, preferably from 350 to 490 mJ, more preferably from 380 to 480 mJ, most preferably from 400 to 470 mJ, in each case in accordance with the opening test described herein; or
ii) can be opened by a rotation of the opening aid with application of an average maximum torque in a range from 0.3 to 0.47 Nm, preferably from 0.35 to 0.46 Nm, more preferably from 0.37 to 0.45 Nm, most preferably from 0.38 to 0.44 Nm, in each case from a rotation angle of 40°;
iii) or both.

A contribution to satisfying at least one of the objects of the invention is made by an embodiment 1 of a use 1 of the sheet-like composite 1 or 2 according in each case to any of its above embodiments for a production of a closed and food-product-filled container.

A contribution to satisfying at least one of the objects of the invention is made by an embodiment 1 of a use 2 of a polyamide selected from the group consisting of a PA410, PA610, PA1010, PA1012, PA612, PA69 and a PA11 or a combination of at least two thereof in a barrier layer of a sheet-like composite having a carrier layer for the production of a food-product container.

In an inventive embodiment 2, the use 2 is designed according to embodiment 1, wherein a carbon fraction of the polyamide is biobased to an extent of at least 40%, preferably to an extent of at least 50%, more preferably to an extent of at least 60%, more preferably to an extent of at least 70%, more preferably to an extent of at least 80%, even more preferably to an extent of at least 90%, even more preferably to an extent of at least 95%, most preferably to an extent of 100%, in accordance with the measurement method described herein.

Features described as preferred in one inventive category are similarly preferred in an embodiment of the further inventive categories.

Abbreviated Term for Polyamides

The abbreviated term, as used herein, for polyamides in the form PAxy, where x and y are each natural numbers, is standardized in DIN EN ISO 1043-1:2012-03, annex A6.

Layers of the Sheet-Like Composite

Two layers are joined to one another when their adhesion to one another goes beyond Van der Waals attraction forces. Preferably, layers joined to one another are one selected from the group consisting of sealed together, adhesively bonded together, and pressed together, or a combination of at least two thereof. Unless otherwise specified, it is possible in a layer sequence for the layers to follow one another indirectly, i.e., with one or at least two intermediate layers, or directly, i.e., without an intermediate layer. This is especially the case in the formulation in which one layer superimposes another layer. A formulation in which a layer sequence comprises listed layers means that at least the specified layers are present in the specified order. Said formulation does not necessarily mean that said layers follow one another directly. A formulation in which two layers are adjacent to another means that said two layers follow one another directly and thus without an intermediate layer. However, said formulation does not say anything about whether the two layers are joined to one another or not. On the contrary, said two layers can be in contact with one another.

Polymer Layers

Hereinafter, the term “polymer layer” refers in particular to the inner polymer layer and the outer polymer layer. A preferred polymer is a polyolefin. The polymer layers can have further constituents. The polymer layers are preferably introduced or applied into the sheet-like composite material in an extrusion process. The further constituents of the polymer layers are preferably constituents which do not adversely affect the behaviour of the polymer melt during application as a layer. The further constituents can, for example, be inorganic compounds, such as metal salts, or further plastics, such as further thermoplastics. However, it is also conceivable that the further constituents are fillers or pigments, for example carbon black or metal oxides. Possible suitable thermoplastics for the further constituents are in particular those easily processable due to a good extrusion behaviour. These include polymers obtained by chain polymerization, especially polyesters or polyolefins, particular preference being given to cyclic olefin copolymers (COC), polycyclic olefin copolymers (POC), especially polyethylene and polypropylene, and very particular preference being given to polyethylene. Preferred polyethylenes are HDPE (high density polyethylene), MDPE (medium density polyethylene), LDPE (low density polyethylene), LLDPE (linear low density polyethylene), VLDPE (very low density polyethylene) and PE (polyethylene) and also mixtures of at least two thereof. It is also possible to use mixtures of at least two thermoplastics. Suitable polymer layers have a melt flow rate (MFR) in a range from 1 to 25 g/10 min, preferably in a range from 2 to 20 g/10 min and particularly preferably in a range from 2.5 to 15 g/10 min, and a density in a range from 0.890 g/cm³ to 0.980 g/cm³, preferably in a range from 0.895 g/cm³ to 0.975 g/cm³, and more preferably in a range from 0.900 g/cm³ to 0.970 g/cm³. The polymer layers preferably have at least one melting temperature in a range from 80 to 155° C., preferably in a range from 90 to 145° C. and particularly preferably in a range from 95 to 135° C.

Inner Polymer Layer

The inner polymer layer is based on thermoplastic polymers, it being possible for said inner polymer layer to contain a particulate inorganic solid. However, it is preferred that the inner polymer layer comprises a thermoplastic polymer to an extent of at least 70% by weight, preferably at least 80% by weight and particularly preferably at least 95% by weight, based in each case on the total weight of the inner polymer layer. Preferably, the polymer or the polymer mixture of the inner polymer layer has a density (as per ISO 1183-1:2004) in a range from 0.900 to 0.980 g/cm³, particularly preferably in a range from 0.900 to 0.960 g/cm³ and most preferably in a range from 0.900 to 0.940 g/cm³.

Carrier Layer

It is possible to use as carrier layer any material which is suitable for this purpose and known to a person skilled in the art and which has a sufficient strength and rigidity to give the container enough stability for said container to substantially maintain its shape in the filled state. This is particularly a necessary feature of the carrier layer, since the invention relates to the technical field of dimensionally stable containers. Such dimensionally stable containers are to be fundamentally distinguished from pouches and bags, which are usually made from thin films. In addition to a range of plastics, preference is given to plant-based fibrous materials, especially chemical pulps, preferably sized, bleached and/or unbleached chemical pulps, particular preference being given to paper and cardboard. Therefore, a preferred carrier layer comprises a multiplicity of fibres. The basis weight of the carrier layer is preferably in a range from 120 to 450 g/m², particularly preferably in a range from 130 to 400 g/m² and most preferably in a range from 150 to 380 g/m². A preferred cardboard generally has a single-layer or multilayer construction and can be coated on one side or on both sides with one cover layer or else multiple cover layers. Furthermore, a preferred cardboard has a residual moisture of less than 20% by weight, preferably from 2 to 15% by weight and particularly preferably from 4 to 10% by weight, based on the total weight of the cardboard. A particularly preferred cardboard has a multilayer construction. More preferably, the cardboard has, on the surface facing towards the surroundings, at least one ply, but particularly preferably at least two plies, of a cover layer, which is known to a person skilled in the art as a “paper coating”. Furthermore, a preferred cardboard has a Scott bond value in a range from 100 to 360 J/m², preferably from 120 to 350 J/m² and especially preferably from 135 to 310 J/m². The aforementioned ranges make it possible to provide a composite from which a container of high tightness can be folded easily and within small tolerances.

The carrier layer is characterized by a bending resistance, which can be measured using a bending measurement instrument. The bending measurement instrument used is a Code 160 from Lorentzen & Wettre, Sweden. The carrier layer preferably has, in a first direction, a bending resistance in a range from 80 to 550 mN. In the case of a carrier layer comprising a multiplicity of fibres, the first direction is preferably an orientation direction of the fibres. A carrier layer comprising a multiplicity of fibres further preferably has, in a second direction perpendicular to the first direction, a bending resistance in a range from 20 to 300 mN. The samples used for measuring the bending resistance using the above measurement instrument have a width of 38 mm and a clamping length of 50 mm. A preferred sheet-like composite having the carrier layer has a bending resistance in the first direction in a range from 100 to 700 mN. Further preferably, the aforementioned sheet-like composite has, in the second direction, a bending resistance in a range from 50 to 500 mN. The samples of the sheet-like composite that are used for measurement using the above measurement instrument also have a width of 38 mm and a clamping length of 50 mm.

Barrier Layer

It is possible to use as barrier layer any material which is suitable for this purpose and known to a person skilled in the art and which has a sufficient barrier action especially with respect to oxygen. According to the invention, the barrier layer is preferably a polymer barrier layer. According to the invention, it may prove to be advantageous when the polymer barrier layer has a melting temperature in a range of more than 155 to 300° C., preferably in a range from 160 to 280° C. and particularly preferably in a range from 170 to 270° C. Further preferably, the polymer barrier layer has a basis weight in a range from 2 to 120 g/m², preferably in a range from 3 to 60 g/m², particularly preferably in a range from 4 to 40 g/m² and further preferably from 6 to 30 g/m². Further preferably, the polymer barrier layer is obtainable from melts, for example by extrusion, especially layer extrusion. Further preferably, the polymer barrier layer can also be introduced into the sheet-like composite via lamination. Here, it is preferred that a film is incorporated into the sheet-like composite. According to another embodiment, it is also possible to select polymer barrier layers obtainable by deposition from a solution or dispersion of polymers.

Preferably, at least one polymer layer, further preferably the inner polymer layer or the outer polymer layer or both, has a melting temperature below the melting temperature of the barrier layer, especially the polymer barrier layer. Here, the melting temperatures of the polymer layer, especially the inner polymer layer, and the melting temperature of the barrier layer differ preferably by at least 1 K, particularly preferably by at least 10 K, even more preferably by at least 50 K, further preferably at least 100 K. The temperature difference should preferably only be selected high enough for there to be no melting of the barrier layer, especially no melting of the polymer barrier layer, during folding.

According to a further preferred embodiment, the barrier layer can be present as a layer composite composed of one or more polymer layers having a metal layer or a metal oxide layer or both. Such a layer is, for example, obtainable by vapour depositing a metal onto a polymer layer. A preferred method for this purpose is physical vapour deposition.

Outer Side

The outer side of the sheet-like composite is a surface of a ply of the sheet-like composite, which surface is intended, in a container to be produced from the sheet-like composite, to be in contact with the surroundings of the container. This does not conflict with the fact that, in individual regions of the container, outer sides of various regions of the composite are folded on top of one another or joined to one another, for example sealed on top of one another.

Inner Side

The inner side of the sheet-like composite is a surface of a ply of the sheet-like composite, which surface is intended, in a container to be produced from the sheet-like composite, to be in contact with the filling material of the container, preferably a food product.

Adhesion/Adhesion-Promoter Layer

An adhesion-promoter layer can be situated between layers which are not directly adjacent to one another, preferably between the barrier layer and the inner polymer layer. Possible adhesion promoters in an adhesion-promoter layer are all plastics which are suited as a result of functionalization by means of suitable functional groups to generating a firm connection as a result of the formation of ionic bonds or covalent bonds in relation to a surface of a particular adjacent layer. Preferably, they are functionalized polyolefins obtained by copolymerization of ethylene with acrylic acids such as acrylic acid, methacrylic acid, crotonic acid, acrylates, acrylate derivatives or double-bond-bearing carboxylic anhydrides, for example maleic anhydride, or at least two thereof. Preference is given thereamong to polyethylene-maleic anhydride graft polymers (EMAH), ethylene-acrylic acid copolymers (EAA) or ethylene-methacrylic acid copolymers (EMAA), which are, for example, sold under the trade names Bynel® and Nucrel®0609HSA by DuPont or Escor®6000ExCo by ExxonMobile Chemicals.

According to the invention, it is preferred that the adhesion between a carrier layer, a polymer layer or a barrier layer in relation to the particular next layer is at least 0.5 N/15 mm, preferably at least 0.7 N/15 mm and particularly preferably at least 0.8 N/15 mm. In one embodiment according to the invention, it is preferred that the adhesion between a polymer layer and a carrier layer is at least 0.3 N/15 mm, preferably at least 0.5 N/15 mm and particularly preferably at least 0.7 N/15 mm. Furthermore, it is preferred that the adhesion between a barrier layer and a polymer layer is at least 0.8 N/15 mm, preferably at least 1.0 N/15 mm and particularly preferably at least 1.4 N/15 mm. If a barrier layer indirectly follows a polymer layer via an adhesion-promoter layer, it is preferred that the adhesion between the barrier layer and the adhesion-promoter layer is at least 1.8 N/15 mm, preferably at least 2.2 N/15 mm and particularly preferably at least 2.8 N/15 mm. In a particular embodiment, the adhesion between the individual layers is strongly formed to the extent that, in an adhesion test, there is a tear of a carrier layer, or a so-called cardboard fibre tear in the case of a cardboard as carrier layer. In a preferred embodiment, the sheet-like composite comprises no adhesion-promoter layer between the barrier layer and the carrier layer.

Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. A further preferred polyolefin is an mPolyolefin (polyolefin produced by means of a metallocene catalyst). Suitable polyethylenes have a melt flow rate (MFR) in a range from 1 to 25 g/10 min, preferably in a range from 2 to 20 g/10 min and particularly preferably in a range from 2.5 to 15 g/10 min, and a density in a range from 0.910 g/cm³ to 0.935 g/cm³, preferably in a range from 0.912 g/cm³ to 0.932 g/cm³, and more preferably in a range from 0.915 g/cm³ to 0.930 g/cm³.

mPolymer

An mPolymer is a polymer which has been produced by means of a metallocene catalyst. A metallocene is an organometallic compound in which a central metal atom is arranged between two organic ligands, such as, for example, cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two thereof.

Extrusion

During extrusion, the polymers are usually heated to temperatures of from 210 to 350° C., measured at the molten polymer film below the exit at the extruder die. The extrusion can be achieved using extrusion tools which are known to a person skilled in the art and commercially available, such as, for example, extruders, extruder screws, feed blocks, etc. Situated at the end of the extruder is preferably an opening through which the polymer melt is pressed. The opening can have any shape which makes it possible to extrude the polymer melt onto the composite precursor. For example, the opening can be angular, oval or round. The opening preferably has the shape of a slot of a funnel. In a preferred embodiment of the method, application is carried out through a slot. The slot preferably has a length in a range from 0.1 to 100 m, preferably in a range from 0.5 to 50 m, particularly preferably in a range from 1 to 10 m. Furthermore, the slot preferably has a width in a range from 0.1 to 20 mm, preferably in a range from 0.3 to 10 mm, particularly preferably in a range from 0.5 to 5 mm. During the application of the polymer melt, it is preferred that the slot and the composite precursor move relative to one another. For instance, preference is given to a method in which the composite precursor moves relative to the slot.

In a preferred extrusion coating process, the polymer melt is stretched during application, this stretching being achieved preferably by melt stretching, very particularly preferably by monoaxial melt stretching. To this end, the layer is applied in the molten state to the composite precursor by means of a melt extruder, and the applied layer, which is still in the molten state, is then stretched in a preferably monoaxial direction in order to achieve an orientation of the polymer in said direction. Thereafter, the applied layer is left to cool for the purposes of heat setting. In this connection, it is particularly preferred that the stretching is achieved by at least the following application steps:
b1. exiting of the polymer melt as melt film via at least one extruder die slot at an exit velocity Vₒᵤₜ;
b2. application of the melt film to the composite precursor moving relative to the at least one extruder die slot at a movement velocity V_{for};
   where Vₒᵤₜ<V_{for}. It is especially preferred that V_{for} is greater than Vₒᵤₜ by a factor in the range from 5 to 200, particularly preferably in a range from 7 to 150, further preferably in a range from 10 to 50 and most preferably in a range from 15 to 35. In this connection, it is preferred that the V_{for} is at least 100 m/min, particularly preferably at least 200 m/min and very particularly preferably at least 350 m/min, but is usually not above 1300 m/min. After the melt layer has been applied to the composite precursor by means of the above-described stretching process, the melt layer can be left to cool for the purposes of heat setting, this cooling being achieved preferably by quenching via contact with a surface held at a temperature in a range from 5 to 50° C., particularly preferably in a range from 10 to 30° C.

According to a further preferred embodiment, the area which has exited is cooled to a temperature below the lowest melting temperature of the polymers provided in said area or its flanks, and then at least the flanks of the area are separated from said area. The cooling can be carried out in any manner which is familiar to a person skilled in the art and appears to be suitable. Preference is also given here to the heat setting already described above. Thereafter, at least the flanks are separated from the area. The separation can be carried out in any manner which is familiar to a person skilled in the art and appears to be suitable. Preferably, the separation is achieved by means of a knife, laser beam or water jet, or a combination of two or more thereof, particular preference being given to the use of knives, especially knives for shearing.

Food Product

The present sheet-like composite and the container precursor are preferably formed for the production of a food-product container. Furthermore, the inventive closed container is preferably a food-product container. Possible food products are all foods known to a person skilled in the art for human consumption and also animal feeds. Preferred food products are liquid above 5° C., for example milk products, soups, sauces, non-carbonated drinks

Colourant

According to DIN 55943:2001-10, colourant is the generic term for all colouring substances, especially for dyes and pigments. A preferred colourant is a pigment. A preferred pigment is an organic pigment. Pigments significant in connection with the invention are in particular the pigments mentioned in DIN 55943:2001-10 and the pigments mentioned in “Industrial Organic Pigments, Third Edition.” (Willy Herbst, Klaus Hunger Copyright © 2004 WILEY-VCH Verlag GmbH & Co. KGaA, Weinheim ISBN: 3-527-30576-9).

Container

The inventive closed container can have a multiplicity of different shapes, but preference is given to an essentially cuboidal structure. Furthermore, the entire area of the container can be formed from the sheet-like composite, or the container can have a 2-part or multipart construction. In the case of a multipart construction, it is conceivable that, besides the sheet-like composite, use can also be made of other materials, for example plastic, which can be used especially in the head or base regions of the container. However, it is preferred here that the container is constructed from the sheet-like composite to an extent of at least 50%, particularly preferably to an extent of at least 70% and further preferably to an extent of at least 90% of the area. Furthermore, the container can have a device for emptying the contents. This can, for example, be formed from a polymer or mixture of polymers and applied to the outer side of the container. It is also conceivable that said device is integrated into the container by direct injection moulding. According to a preferred embodiment, the inventive container has at least one edge, preferably from 4 to 22 or else more edges, particularly preferably from 7 to 12 edges. In the context of the present invention, edges are understood to mean regions arising during folding of an area. Exemplary edges include the longitudinal contact regions of two wall areas of the container in each case, also referred to herein as longitudinal edges. In the container, the container walls are preferably the areas of the container that are framed by the edges. Preferably, the interior of an inventive container comprises a food product. Preferably, the closed container does not contain any lid or base, or both, not formed in one piece with the sheet-like composite. A preferred closed container comprises a food product.

Hole

The at least one hole provided in the carrier layer according to preferred embodiments can have any shape which is known to a person skilled in the art and suitable for various closures or drinking straws. In many cases, the holes, in top view, have curves. For instance, the holes can be essentially circular, oval, elliptical or drop-shaped. The shape of the at least one hole in the carrier layer usually also predetermines the shape of the opening generated in the container either by an openable closure joined to the container, through which the contents of the container are dispensed from the container after opening, or by a drinking straw. This means that, in many cases, the openings of the opened container have shapes comparable or even identical to the at least one hole in the carrier layer. Embodiments of the sheet-like composite having a single hole are primarily used for releasing the food product situated in the container made from the sheet-like composite. A further hole can be provided especially for air circulation in the container during the release of the food product.

In connection with the covering of the at least one hole of the carrier layer, it is preferred that the hole-covering layers are joined to one another at least in part, preferably to an extent of at least 30%, preferably to an extent of at least 70% and particularly preferably to an extent of at least 90% of the area formed by the at least one hole. Furthermore, it is preferred that the hole-covering layers are joined to one another at the edges of the at least one hole and are in contact with the edges preferably in a joined manner in order to thus achieve an improved tightness over a connection stretching across the entire hole area. In many cases, the hole-covering layers are joined to one another over the region formed by the at least one hole in the carrier layer. This leads to a good tightness of the container formed from the composite and thus to the desired long shelf life of the foods kept in the container.

Opening/Opening Aid

In most cases, the opening in the container is generated by at least partial destruction of the hole-covering layers covering the at least one hole. This destruction can be achieved by cutting, by pushing into the container or by pulling out from the container. The destruction can be achieved by means of an opening aid which is joined to the container and arranged in the region of the at least one hole, usually above the at least one hole, for example even by means of a drinking straw, which is jabbed through the hole-covering layers. Furthermore, it is preferred in one embodiment according to the invention that an opening aid is provided in the region of the at least one hole. Here, it is preferred that the opening aid is provided on the area of the composite that represents the outer side of the container. Furthermore, the container preferably comprises a closure, for example a lid, on the outer side of the container. In this connection, it is preferred that the closure covers the hole at least in part, preferably in full. Thus, the closure protects the hole-covering layers, which are less robust compared to the regions outside of the at least one hole, from damaging mechanical action. For the opening of the hole-covering layers covering the at least one hole, the closure comprises in many cases the opening aid. Suitable as such are, for example, hooks for tearing out at least a portion of the hole-covering layers, edges or blades for cutting into the hole-covering layers or spikes for pushing through the hole-covering layers or a combination of at least two thereof. In many cases, these opening aids are mechanically coupled with a screw-on lid or a cap of the closure, for example via a hinge, and so the opening aid, with operation of the screw-on lid or the cap, acts on the hole-covering layers in order to open the closed container. Occasionally, such closure systems, comprising composite layers covering a hole, and openable closures covering said hole and having opening aids, are referred to in the specialist literature as “overcoated holes” having “applied fitments”.

### Measurement Methods

The following measurement methods were used in the context of the invention. Unless otherwise specified, the measurements were carried out at an ambient temperature of 23° C., an ambient air pressure of 100 kPa (0.986 atm) and a relative air humidity of 50%.

MFR Value

MFR value is measured in accordance with the standard ISO 1133 (unless otherwise specified, at 190° C. and 2.16 kg).

Density

Density is measured in accordance with the standard ISO 1183-1.

Melting Temperature

Melting temperature is determined on the basis of the DSC method ISO 11357-1, -5. Instrument calibration is done according to information from the manufacturer on the basis of the following measurements:
temperature indium-onset temperature,
heat of fusion indium,
temperature zinc-onset temperature.

Oxygen Permeation Rate

Oxygen permeation rate is determined in accordance with the standard ISO 14663-2 annex C at 20° C. and 65% relative air humidity.

Cardboard Moisture Content

Cardboard moisture content is measured in accordance with the standard ISO 287:2009.

Adhesion

Adhesion between two adjacent layers is determined by fixing them on a 90° peel test instrument, for example “German rotating wheel fixture” from Instron, on a rotatable roller rotating at 40 mm/min during the measurement. The samples were cut beforehand into strips of 15 mm in width. On one side of the sample, the plies are detached from one another and the detached end is clamped into a pulling device directed vertically upwards. A measurement instrument for determining tensile force is attached to the pulling device. During rotation of the roller, the force required to separate the plies from one another is measured. Said force corresponds to the adhesion of the layers to one another and is specified in N/15 mm. The separation of the individual layers can, for example, be achieved mechanically, or by a specific pre-treatment, for example by soaking the sample for 3 min in 30% acetic acid warmed to 60° C.

Detection of Colourants

Detection of organic colourants can be carried out in accordance with the methods described in “Industrial Organic Pigments, Third Edition.” (Willy Herbst, Klaus Hunger Copyright © 2004 WILEY-VCH Verlag GmbH & Co. KGaA, Weinheim ISBN: 3-527-30576-9).

Biobased Polyamide

The standard ASTM D6866-12 method B was used to determine whether and to what extent the carbon fraction of the polyamide is biobased.

Opening Test

To determine the average opening work and the maximum torque from 40°, the filled container having a lid is measured using the opening aid described in EP1 812 298 B1 using a torque-controlled force transducer Torque Pro from SEA Datentechnik, Cologne, Germany.

Preparation and Measurement of the Samples:

The samples to be measured are stored at 23° C. for 24 hours. For the measurement, the container is fixed in the measurement device and the lid of the opening aid is fixed with the force transducer. For each measurement, 3 containers are measured in succession. This involves, firstly, determining the opening work (in mJ) required to open the containers using the opening aid and, secondly, determining the maximum torque from a rotation angle of 40°. The arithmetic mean is calculated from the values obtained for the 3 containers.

Methylene/Amide Coefficient

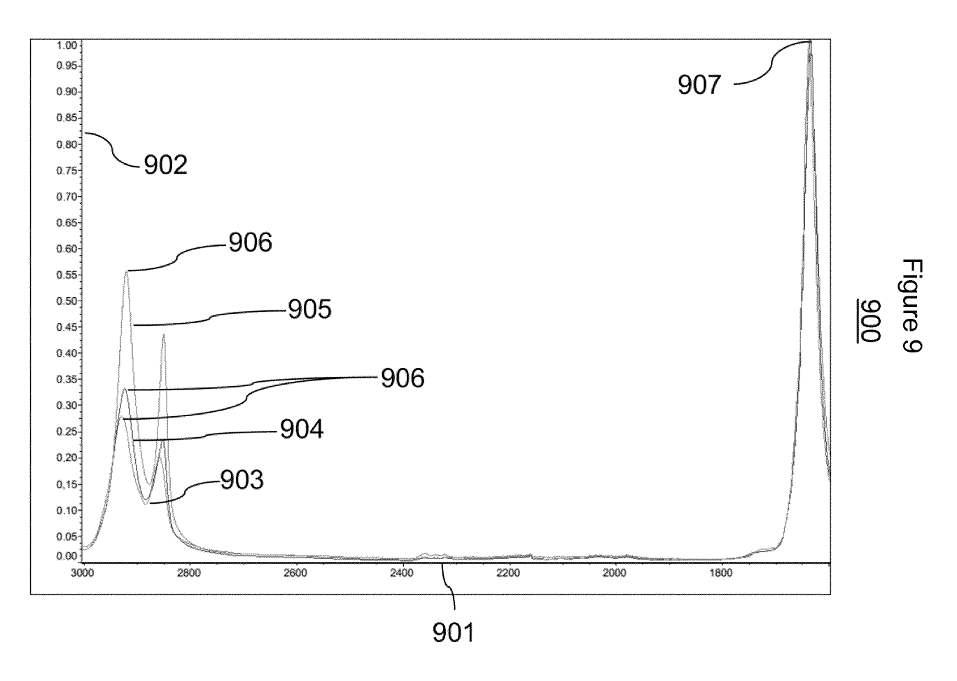

The methylene/amide coefficient used herein is determined by means of ATR infrared spectroscopy (ATR—attenuated total reflection). For this purpose, the sample is analysed using an FT-IR microscope (Thermo Scientific Nicolet™ iN™ 10 MX Infrared Imaging Microscope from Thermo Fisher Scientific Inc). What is recorded is an ATR spectrum of the sample to be measured at the previously identified position in a wave number range from 3500 to 1600 cm⁻¹ with a resolution of 4 cm⁻¹ at 45° by means of a diamond as detector tip. FIG. 9, which is described in more detail below, shows by way of example 3 such spectra for various measurements. The measured spectrum comprises a local maximum (peak) of the measured absorption/absorbance in the wave number range between 2900 to 2950 cm⁻¹. This first local maximum is caused by the vibration of the methylene (C—H₂) molecular group. Furthermore, the spectrum comprises a further local maximum in the wave number range between 1600 to 1700 cm⁻¹. This further local maximum is caused by the vibration of the amide (N—H) molecular group. The spectrum is normalized, and so the further local maximum of the amide vibration has the value of 1. The methylene/amide coefficient is determined as the quotient formed from the normalized methylene vibration maximum (first local maximum) and the normalized amide vibration maximum (further local maximum). Therefore, the following definition is applicable:

Methylene/amide coefficient=Iₘₐₓ(2900 to 2950 cm⁻¹)/Iₘₐₓ(1600 to 1700 cm⁻¹),

where Iₘₐₓ is in each case the value of the normalized maximum of the ATR spectrum in the specified wave number range.

Butyrometric Determination of the Fat Content of Milk

The fat content of the milk was determined in accordance with DIN 10479-2, section 9.2. Here, the arithmetic mean of 5 samples was determined.

The invention will be described more precisely below by means of examples and drawings, said examples and drawings not signifying any restriction of the invention. Furthermore, unless otherwise specified, the drawings are not true to scale.

For the examples, laminates having the following layer construction and layer sequence were generated by means of a layer extrusion method.

TABLE 1
General construction of the exemplary and comparative laminates

| | | Basis |
|---|---|---|
| | | weight |
| Layer name | Material | [g/m²] |
| Outer polymer layer | LDPE 23L430 from Ineos GmbH, | 15 |
| | Cologne | |
| Carrier layer | Cardboard: Stora Enso Natura T Duplex | 191 |
| | double coating, Scott bond 200 J/m² | |
| Barrier layer | See below | 8 |
| Adhesion-promoter | Yparex 9207 from Yparex B.V., | 4 |
| layer | Enschede | |
| Inner polymer layer | LDPE 19N430 from Ineos GmbH, | 31 |
| (103) | Cologne | |

Production of Laminate and Container

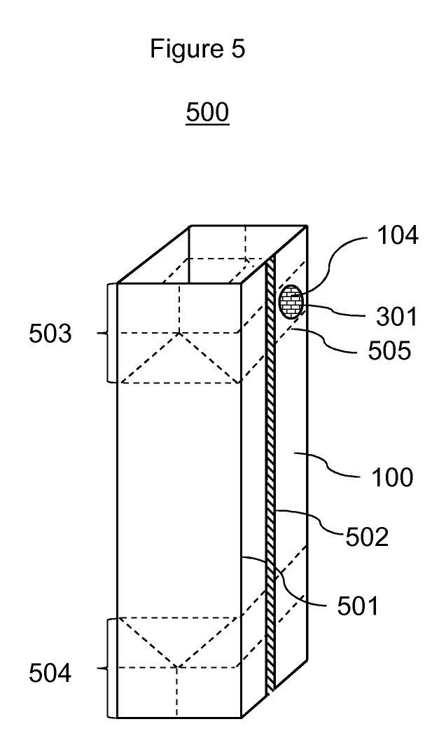

The laminate is produced using an extrusion coating system from Davis Standard. In the first step, the carrier layer is provided with a hole and the outer polymer layer is then applied to the carrier layer. In the second step, the barrier layer is applied together with the adhesion layer and the inner polymer layer to the carrier layer previously coated with the outer polymer layer. The individual layers are applied by melting the polymers in an extruder. In the application of a polymer in a layer, the resultant melt is transferred into a die via a feed block and extruded onto the carrier layer. From the laminate thus obtained, a jacket-like container precursor of the form shown in FIG. 5 was obtained by folding 4 longitudinal folds and sealing a longitudinal seam. From this jacket, a closed container is generated in the standard filling machine CFA 712, SIG Combibloc, Linnich.

As described above, the carrier layer was first provided with a hole, onto which the opening aid of EP1 812 298 B1 is applied. Said opening aid opens the container as per paragraph in EP1 812 298 B1 with a pushing and cutting movement through the membrane spanning the hole. In the case of optimal function, approximately 90% of the circumference of a region of the membrane that is predefined by the cutting ring are cut through and there remains only a connection to the container at one point. The membrane folds away to the side and the product can be poured out with no interferences. In the case of a non-inventive material selection, constraints may arise during the opening of the container.

To determine the change in the fat content of milk, 100 containers were filled on the standard filling machine CFA 712, SIG Combibloc, Linnich, with milk having a fat content of 3.5%, said fat content of the milk being determined in accordance with the above method “Butyrometric determination of the fat content of milk”. The containers were then stored under standard conditions (ambient temperature of 23° C., a relative air humidity of 50%) for 6 months. Thereafter, the fat content of the milk was determined again in accordance with the aforementioned measurement method.

TABLE 2
Features of the barrier layer

| | | | Methylene/ | Biobased |
|---|---|---|---|---|
| | | | amide | fraction of |
| | Composition of the | | coefficient | the barrier |
| | barrier layer | | of the | layer |
| | Polyamide | Product name | barrier layer | [%] |
| Comparative | PA6 | Durethan B31F, | 0.28 | 0 |
| example 1 | | Lanxess | | |
| | | Deutschland | | |
| | | GmbH | | |
| Comparative | PA6 | Akulon ® | 0.27 | 0 |
| example 2 | | XP32, DSM | | |
| | | Engineering | | |
| | | Plastics B.V. | | |
| Example 1 | PA1010 | VESTAMID ® | 0.56 | 100 |
| | | Terra | | |
| | | DS, Evonik | | |
| | | Industries | | |
| Example 2 | PA410 | EcoPaxx ® | 0.33 | 70 |
| | | Q170E, DSM | | |
| | | Engineering | | |
| | | Plastics B.V. | | |
| Example 3 | PA610 | VESTAMID ® | 0.41 | 62 |
| | | Terra HS, | | |
| | | Evonik | | |
| | | Industries | | |
| Example 4 | PA11 | Rilsan ® | 0.58 | 100 |
| | | BES N0 | | |
| | | MED, Arkema | | |
| Example 5 | PA1012 | VESTAMID ® | 0.57 | 100 |
| | | Terra DD, | | |
| | | Evonik | | |
| | | Industries | | |

TABLE 3
Properties of the container

| | | | Milk fat content |
|---|---|---|---|
| | Opening | Maximum torque | after 6-month |
| | work | from 40° | storage period |
| | [mJ] | [Nm] | [%] |
| Comparative | 553 | 0.49 | 3.7 |
| example 1 | | | |
| Comparative | 565 | 0.51 | 3.8 |
| example 2 | | | |
| Example 1 | 463 | 0.42 | 3.5 |
| Example 2 | 463 | 0.41 | 3.5 |
| Example 3 | 433 | 0.4 | 3.5 |
| Example 4 | 411 | 0.39 | 3.5 |
| Example 5 | 445 | 0.41 | 3.5 |

Unless otherwise specified in the description or the particular figure:

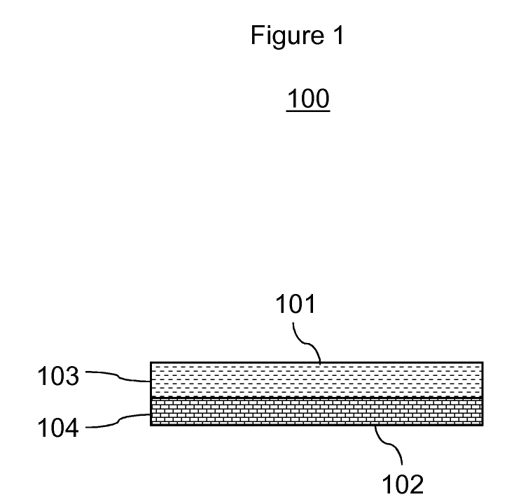

FIG. 1 shows a schematic cross section of an inventive sheet-like composite;

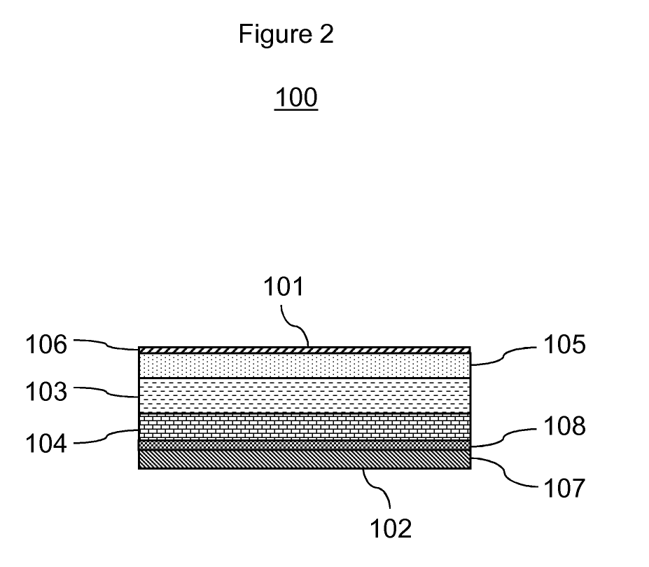

FIG. 2 shows a schematic cross section of a further inventive sheet-like composite;

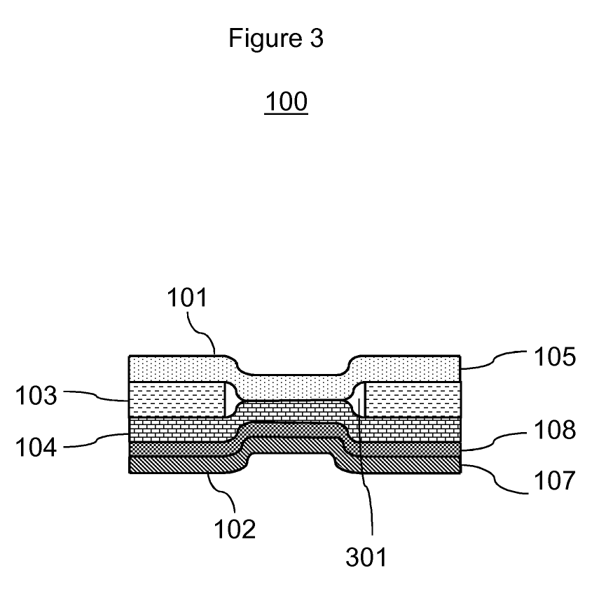

FIG. 3 shows a schematic cross section of a further inventive sheet-like composite;

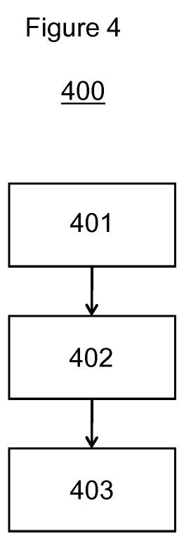

FIG. 4 shows a flow chart of an inventive method for producing a sheet-like composite;

FIG. 5 shows a schematic depiction of an inventive container precursor;

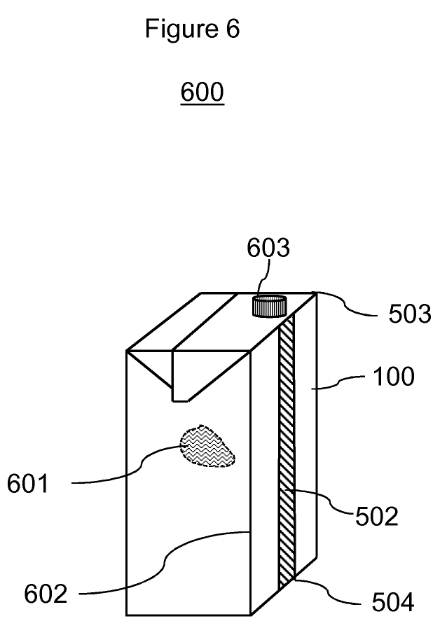

FIG. 6 shows a schematic depiction of an inventive closed container;

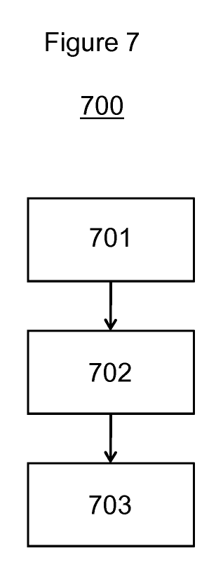

FIG. 7 shows a flow chart of an inventive method for producing a container precursor;

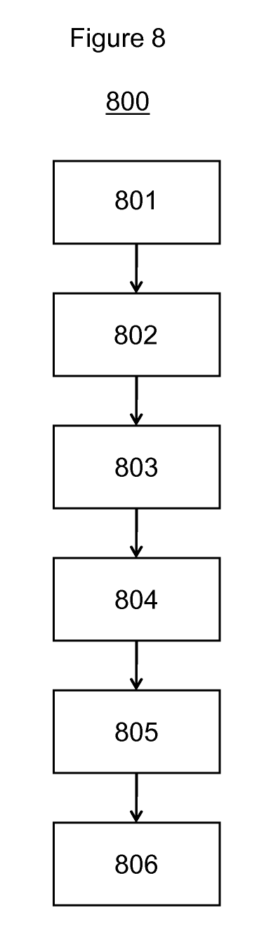

FIG. 8 shows a flow chart of an inventive method for producing a closed container;

and

FIG. 9 shows a graph comprising measured results from ATR infrared spectroscopy of a non-inventive laminate and of two inventive sheet-like composites

in a schematic manner and in a manner which is not true to scale.

FIG. 1 shows a schematic cross section of an inventive sheet-like composite 100. The sheet-like composite 100 consists of the following layers of a layer sequence from an outer side 101 of the sheet-like composite 100 to an inner side 102 of the sheet-like composite 100: a carrier layer 103 and a barrier layer 104. Here, the carrier layer 103 consists of a cardboard Stora Enso Natura T Duplex with double coating. The cardboard is characterized by a Scott bond value of 200 J/m² and a basis weight of 191 g/m². The barrier layer 104 comprises a polyamide PA610 Vestamid® Terra HS16 from Evonik Industries AG, Marl, Germany. Furthermore, the barrier layer 104 is characterized by a methylene/amide coefficient, as determined in accordance with the method described herein, of 0.60.

FIG. 2 shows a schematic cross section of a further inventive sheet-like composite 100. The sheet-like composite 100 consists of the following layers of a layer sequence from an outer side 101 of the sheet-like composite 100 to an inner side 102 of the sheet-like composite 100: a colour layer 106, in this case a decoration composed of colours of the colour series MAS from SunChemical, Parssippany, USA; an outer polymer layer 105 consisting of an LDPE 23L430 from Ineos GmbH, Cologne, having a basis weight of 15 g/m²; a carrier layer 103 composed of a cardboard Stora Enso Natura T Duplex with double coating, a Scott bond value of 200 J/m² and a basis weight of 191 g/m²; a barrier layer 104 consisting of a polyamide PA410 EcoPaXX® Q170E from DSM N.V., Heerlen, the Netherlands, having a basis weight of 8 g/m²; an adhesion-promoter layer 108 composed of Yparex 9207 from Yparex B.V., Enschede, having a basis weight of 4 g/m²; and an inner polymer layer 107 composed of an LDPE 19N430 from Ineos GmbH, Cologne, having a basis weight of 40 g/m². Here, the barrier layer 104 is characterized by a methylene/amide coefficient, as determined in accordance with the method described herein, of 0.41. Furthermore, a carbon fraction of the PA410 is biobased to an extent of at least 70% in accordance with the measurement method described herein.

FIG. 3 shows a schematic cross section of a further inventive sheet-like composite 100. The sheet-like composite 100 of FIG. 3 is formed like the sheet-like composite 100 of FIG. 2, though the sheet-like composite 100 in FIG. 3 does not contain the colour layer 106. Furthermore, the carrier layer 103 according to FIG. 3 has a hole 301. The hole 301 is covered by the outer polymer layer 105, the barrier layer 104, the adhesion-promoter layer 108 and the inner polymer layer 107 as hole-covering layers. Here, the hole-covering layers in the hole 301 are joined to one another across 80% of an area of the hole 301.

FIG. 4 shows a flow chart of an inventive method 400 for producing a sheet-like composite 100. The method 100 comprises a method step a) 401, in which a sheet-like composite precursor consisting of a carrier layer 103 composed of a cardboard Stora Enso Natura T Duplex with double coating is provided. In a method step b) 402, a composition consisting of a polyamide PA1010 Vestamid® Terra DS16 from Evonik Industries AG, Marl, Germany is provided. In a method step c) 403, a first side of the carrier layer 103 is superimposed with the composition by layer extrusion thereby obtaining a barrier layer 104 superimposing the carrier layer 103 on the first side. Here, the composition is characterized by a methylene/amide coefficient, as determined in accordance with the method described herein, of 0.56. Furthermore, a carbon fraction of the PA1010 is biobased to an extent of 100% in accordance with the measurement method described herein.

FIG. 5 shows a schematic depiction of an inventive container precursor 500. The container precursor 500 comprises the sheet-like composite 100 of FIG. 3 with 4 folds 501. The sheet-like composite 100 is a blank for producing an individual closed container 600. The container precursor 500 is jacket-like and comprises a longitudinal seam 502, in which a first longitudinal edge and a further longitudinal edge of the sheet-like composite 100 are sealed together. Furthermore, the container precursor 500 comprises a hole 301 in the carrier layer 103. The hole 301 is covered by the outer polymer layer 105 (not shown), the barrier layer 104, the adhesion-promoter layer 108 (not shown) and the inner polymer layer 107 (not shown) as hole-covering layers. By folding along creases 505 and joining folded regions in a head region 503 and a base region 504 of the container precursor 500, it is possible to obtain a closed container 600. Such a closed container 600 is depicted in FIG. 6.

FIG. 6 shows a schematic depiction of an inventive closed container 600. The closed container 600 is produced from the container precursor 500 according to FIG. 5. The closed container 600 comprises a food product 601 and has 12 edges 602. Furthermore, the closed container 600 is joined to a lid having an opening aid 603, which lid covers the hole 301 on the outer side 101 of the sheet-like composite 100. Here, the lid 603 comprises, in its interior, a cutting tool as opening aid.

FIG. 7 shows a flow chart of an inventive method 700 for producing a container precursor 500. In a method step A. 701, the sheet-like composite 100 according to FIG. 3 is provided. This comprises a first longitudinal edge and a further longitudinal edge. In a method step B. 702, the sheet-like composite 100 is folded. In a method step C. 703, the first longitudinal edge and the further longitudinal edge are pressed on top of one another and joined to one another by heat sealing. Thus, a longitudinal seam 502 is obtained. The container precursor 500 according to FIG. 5 is produced according to what has been described above.

FIG. 8 shows a flow chart of an inventive method 800 for producing a closed container 600. In a method step a. 801, the container precursor 500 according to FIG. 5 is provided. In a method step b. 802, a base region 504 of the container precursor 500 is formed by folding of the sheet-like composite 100. In a method step c. 803, the base region 504 is closed by sealing with hot air of a temperature of 300° C. In a method step d. 804, the container precursor 500 is filled with a food product 601, and, in a method step e. 805, the container precursor 500 is closed by sealing in a head region 503 thereby obtaining the closed container 600. In a method step f. 806, the closed container 600 is joined to an opening aid 603.

FIG. 9 shows a graph 900 comprising measured results from ATR infrared spectroscopy of a non-inventive laminate and of two inventive sheet-like composites 100. The x-axis 901 shows the wave number in cm⁻¹. The y-axis 902 shows a measured absorption/absorbance. Here, the curves 903 to 905 in the graph 900 are each normalized to a further local maximum 907 in accordance with the methylene/amide coefficient measurement method. The further local maximum 907 of each curve 903 to 905 is in a wave number range from 1600 to 1700 cm⁻¹. Furthermore, each curve 903 to 905 comprises a first local maximum 906 in a wave number range from 2900 to 2950 cm⁻¹. The curve 903 resulted from an ATR infrared spectroscopy measurement, in accordance with the above methylene/amide coefficient measurement method, of a PA6 (non-inventive), the curve 904 resulted from that of a PA40 (inventive), and the curve 905 resulted from that of a PA1010 (inventive).

### LIST OF REFERENCE SIGNS

100 Inventive sheet-like composite
101 Outer side
102 Inner side
103 Carrier layer
104 Barrier layer
105 Outer polymer layer
106 Colour layer
107 Inner polymer layer
108 Adhesion-promoter layer
301 Hole
400 Inventive method
401 Method step a)
402 Method step b)
403 Method step c)
500 Inventive container precursor
501 Fold
502 Longitudinal seam
503 Head region
504 Base region
505 Crease
600 Inventive closed container
601 Food product
602 Edge
603 Lid with opening aid
700 Inventive method
701 Method step A.
702 Method step B.
703 Method step C.
800 Inventive method
801 Method step a.
802 Method step b.
803 Method step c.
804 Method step d.
805 Method step e.
806 Method step f.
900 Graph with measured results from ATR spectroscopy
901 Wave number in cm⁻¹
902 Normalized absorption/absorbance
903 Measurement on PA6
904 Measurement on PA410
905 Measurement on PA1010
906 First local maximum
907 Further local maximum

1. A sheet-like composite comprising as layers of a layer sequence from an outer side of the sheet-like composite to an inner side of the sheet-like composite
a) a carrier layer, and
b) a barrier layer;
said barrier layer
a. comprising a polyamide, and
b. being characterized by a methylene/amide coefficient, as determined in accordance with the method described herein, in a range from 0.3 to 0.7.

2. The sheet-like composite according to claim 1, wherein the barrier layer consists of the polyamide,
said polyamide being characterized by a methylene/amide coefficient, as determined in accordance with the method described herein, in a range from 0.3 to 0.7.

3. The sheet-like composite according to claim 1, wherein a carbon fraction of the polyamide is biobased to an extent of at least 40% in accordance with the measurement method described herein.

4. The sheet-like composite according to claim 1, wherein the polyamide is obtainable by polycondensation from a diacid and a diamine.

5. The sheet-like composite according to claim 1, wherein the polyamide is one selected from the group consisting of a PA410, PA610, PA1010, PA1012, PA612, PA69 and a PA11 or a combination of at least two thereof.

6. The sheet-like composite according to claim 1, wherein the sheet-like composite comprises no metal to an extent of more than 10% by weight, based on the weight of the sheet-like composite.

7. The sheet-like composite according to claim 1, wherein the sheet-like composite comprises no further layer between the barrier layer and the carrier layer.

8. The sheet-like composite according to claim 1, wherein the sheet-like composite is characterized by an adhesive strength between the carrier layer and the barrier layer of at least 0.3 N/15 mm.

9. The sheet-like composite according to claim 1, wherein the carrier layer has at least one hole, said hole being covered at least by the barrier layer.

10. A method comprising as method steps
a) providing a sheet-like composite precursor comprising a carrier layer;
b) providing a composition comprising a polyamide; and
c) superimposing a first side of the carrier layer with the composition thereby obtaining a barrier layer superimposing the carrier layer on the first side;
said composition being characterized by a methylene/amide coefficient, as determined in accordance with the method described herein, in a range from 0.3 to 0.7.

11. A sheet-like composite obtainable by the method according to claim 10.

12. A container precursor comprising the sheet-like composite according to claim 1.

13. A closed container comprising the sheet-like composite according to claim 1.

14. A method comprising as method steps
A. providing the sheet-like composite according to claim 1, comprising a first longitudinal edge and a further longitudinal edge;
B. folding the sheet-like composite; and
C. contacting the first longitudinal edge with the further longitudinal edge and joining the first longitudinal edge to the further longitudinal edge thereby obtaining a longitudinal seam.

15. A container precursor obtainable by the method according to claim 14.

16. A method comprising as method steps
a. providing the container precursor according to claim 12;
b. forming a base region of the container precursor by folding the sheet-like composite;
c. closing the base region;
d. filling the container precursor with a food product, and
e. closing the container precursor in a head region thereby obtaining a closed container.

17. A closed container obtainable by the method according to claim 16.

18. A closed container comprising a sheet-like composite, said sheet-like composite comprising as layers of a layer sequence from an outer side of the sheet-like composite to an inner side of the sheet-like composite
a) a carrier layer and
b) a barrier layer,
said barrier layer comprising a polyamide,
said carrier layer having at least one hole,
said hole being covered at least by the barrier layer,
said closed container being joined to an opening aid,
said opening aid being arranged and designed for an opening of the closed container in the hole.

19. A use of the sheet-like composite according to claim 1 for a production of a closed and food product-filled container.

20. A use of a polyamide selected from the group consisting of a PA410, PA610, PA1010, PA1012, PA612, PA69 and a PA11 or a combination of at least two thereof in a barrier layer of a sheet-like composite having a carrier layer for the production of a food-product container.
